(19) United States
(12) Patent Application Publication
(10) Pub. No.: US 2020/0168102 A1
(43) Pub. Date: May 28, 2020

(54) PLATOONING SYSTEM

(71) Applicant: Toyota Jidosha Kabushiki Kaisha, Toyota-shi Aichi-ken (JP)

(72) Inventors: Nobuhide Kamata, Susono-shi (JP); Eiji Sakaguchi, Shizuoka-ken (JP); Tomoyuki Kuriyama, Hadano-shi (JP)

(21) Appl. No.: 16/692,777

(22) Filed: Nov. 22, 2019

(30) Foreign Application Priority Data
Nov. 26, 2018 (JP) 2018-220518

(51) Int. Cl. G08G 1/00; G05D 1/02; G05D 1/00; B60W 30/165

(52) U.S. Cl. CPC G08G 1/22; G05D 1/0295; G05D 1/0088; B60W 2550/40; G05D 2201/0213; B60W 2550/30; B60W 30/165

(57) ABSTRACT

The platooning system performs platooning of a vehicle group in which a plurality of vehicles are electronically connected. When a part of the electronic connection is interrupted and the vehicle group is divided into a first vehicle group and a second vehicle group, the platooning system determines a feasible driving support level of a lead vehicle of the second vehicle group. Then, when the determined driving support level is a high-grade driving support level, the platooning system performs platooning of the second vehicle group by driving support based on the high-grade driving support level. On the other hand, when the determined driving support level is a low-grade driving support level, the platooning system controls the operation of the platooning of the second vehicle group on the basis of the information as to whether or not the driver is on board the lead vehicle of the second vehicle group.

### CROSS-REFERENCE TO RELATED APPLICATION

The present application is based on, and claims priority from, Japanese Patent Application Serial Number 2018-220518, filed on Nov. 26, 2018, the disclosure of which is hereby incorporated by reference herein in its entirety.

### FIELD

The present disclosure relates to a platooning system, and more particularly, to a platooning system for organizing a platoon by electronically connecting vehicle spaces of a plurality of vehicles arranged in a column, and for automatically causing one or more vehicles positioned behind a lead vehicle of the platoon to trail the lead vehicle.

### BACKGROUND

A platooning technique called electronic traction is known, in which a platoon is formed and traveled by electronically connecting a plurality of vehicles arranged in a row. In the electronic traction, since the platoon is maintained while data is shared between the vehicles arranged in the row, it is possible to shorten the gap distance between the vehicles, thereby obtaining the effect of improving the fuel efficiency performance by improving the aerodynamic characteristics, and the like. Japanese Patent Laid-Open No. 2000-339599 discloses a technique related to such an electronic traction. Specifically, in the Japanese Patent Laid-Open No. 2000-339599, when a signal of a vehicle abnormality is transmitted from any succeeding vehicle during electronic traction, the platooning of the vehicle located ahead of the vehicle that transmitted the abnormality signal is continued, and the traveling of the vehicle that transmitted the abnormality signal and the vehicle located behind the vehicle are stopped.

### SUMMARY

It is considered that the driving support control supporting the driving of the vehicle is applied to the above-mentioned technique. If the level of the driving support control of the vehicle to which the abnormality signal is transmitted is high, it is assumed that the platooning can be continued without stopping the driving of the vehicle. As described above, considering the level of the driving support control of the vehicle in which the electronic connection is interrupted, further improvement in the convenience of the platooning can be expected.

The present disclosure has been made in view of the above-mentioned problems, and an object thereof is to provide a platooning system capable of optimizing the platooning of each vehicle group when the platoon is divided into a plurality of vehicle groups due to the interruption of the electronic connection in the platooning in which a plurality of vehicles arranged in a row are electronically connected.

In order to solve the above-mentioned problems, a first disclosure is applied to a platooning system. The platooning system is configured to perform platooning by forming a platoon by electrically connecting a plurality of vehicles arranged in a row to each other, and automatically causing a trailing vehicle positioned behind a lead vehicle of the platoon to follow the lead vehicle. The platooning system includes a processor to execute a program defining an operation of the platooning, and a memory to store the program. The program includes a level determination process and a platooning process. When a plurality of the vehicles formed the platoon is divided into a first vehicle group and a second vehicle group behind the first vehicle group by interrupting a part of an electronic connection, the level determination process is configured to determine a driving support level to be realized by a lead vehicle of the second vehicle group. The platooning process is configured to control the operation of the platooning by the second vehicle group based on the determined driving support level.

A second disclosure has the following further features in the first disclosure.

The platooning process includes a high-grade platooning process, and when the driving support level determined by the level determination process is a high-grade driving support level equal to or higher than a predetermined level, the high-grade platooning process is configured to perform platooning of the second vehicle group by driving support based on the high-grade driving support level.

A third disclosure further has the following features in the second disclosure.

The high-grade platooning process includes an evacuation traveling process, and when a position of the second vehicle group belongs to a driving support feasible area corresponding to the high-grade driving support level, the evacuation traveling process is configured to move the second vehicle group to a predetermined safety zone included in the driving support feasible area by the driving support.

A fourth disclosure has the following features in the second or third disclosure.

The high-grade platooning process includes an automatic stopping process, and when the position of the second vehicle group does not belong to a driving support feasible area corresponding to the high-grade driving support level, the automatic stopping process is configured to stop the second vehicle group by the driving support.

A fifth disclosure has the following features in any one of the second to fourth disclosures.

The platooning process includes an information transmission process, and when the driving support level determined by the level determination process is a low-grade driving support level equal to or lower than the predetermined level, the information transmission process is configured to transmit information of the lead vehicle of the second vehicle group to an external device.

A sixth disclosure has the following features in any one of the second to fourth disclosures.

The platooning process includes a driver information acquisition process and a low-grade platooning process. The driver information acquisition process is configured to acquire driver information indicating whether or not the driver is on board the lead vehicle of the second vehicle group. The low-grade platooning process is configured to control the operation of the platooning of the second vehicle group based on the driver information when the driving support level determined by the level determination process is a low-grade driving support level lower than the predetermined level.

A seventh disclosure has the following features in the sixth disclosure.

The low-grade platooning process includes an information transmission process, and when a driver is not on board the lead vehicle of the second vehicle group, the information transmission process is configured to transmit information about a lead vehicle of the second vehicle group including the driving support level and the driver information to an external device.

An eighth disclosure has the following features in the sixth or seventh disclosure.

The low-grade platooning process includes a manual driving process, and when a driver is on board a lead vehicle of the second group, the manual driving process is configured to perform the platooning of the second vehicle group by driving support based on the low-grade driving support level.

According to the first disclosure, even when the vehicle group in the platooning is divided by the interruption of the electronic connection, it is possible to optimize the behavior of platooning of the second vehicle group based on the driving support level of the lead vehicle of the second vehicle group.

According to the second disclosure, when the driving support level of the lead vehicle of the second vehicle group is the high-grade driving support level equal to or higher than the predetermined level, the platooning of the second vehicle group is performed by the driving support based on the high-grade driving support level. As a result, even when the vehicle group is divided by the interruption of the electronic connection, the second vehicle group can perform the platooning using the high-grade driving support level.

According to the third or fourth disclosure, it is possible to optimize the platooning of the second vehicle group according to the high-grade driving support level, depending on whether or not the position of the second vehicle group is in a region where the driving support of the high-grade driving support level can be performed.

According to the fifth disclosure, when the driving support level of the lead vehicle of the second vehicle group is a low-grade driving support level lower than the predetermined level, information of the lead vehicle of the second vehicle group is transmitted to the external device. As a result, it is possible to determine the behavior of the platooning of the second vehicle group in accordance with the determination by the external device.

According to any one of the sixth to eighth disclosures, when the driving support level of the lead vehicle of the second vehicle group is the low-grade driving support level, it is possible to optimize the platooning of the second vehicle group by the low-grade driving support level according to the presence or absence of boarding of the driver.

As described above, according to the present disclosure, even when the electronic connection is interrupted and the platoon is divided into a plurality of vehicle groups, it is possible to optimize the platooning of each vehicle group.

### BRIEF DESCRIPTION OF DRAWINGS

FIG. 1 is a conceptual diagram for explaining functions related to driving support control of a vehicle applied to a platooning system according to a first embodiment;

FIG. 2 is a diagram schematically showing a configuration of the platooning system according to the first embodiment;

FIG. 3 is a diagram showing an example of a platoon of an organized vehicle group;

FIG. 4 is a diagram showing an example of a case where an electronic connection is interrupted in a part of the platoon of the vehicle group;

FIG. 5 is a diagram for explaining platooning executed when the electronic connection is interrupted.

FIG. 6 is a diagram for explaining an example of the platooning executed when a driving support level of a lead vehicle of a second vehicle group is a low-grade driving support level;

FIG. 7 is a block diagram showing a configuration example of a driving support control device of the vehicle applied to the platooning system according to the first embodiment;

FIG. 8 is a block diagram showing an example of a configuration of the platooning system according to the first embodiment;

FIG. 9 is a block diagram showing an example of a configuration of various processes included in a platooning process;

FIG. 10 is a flowchart showing a routine of a platooning management process executed in the platooning system according to the first embodiment;

FIG. 11 is a flow chart showing a subroutine executed in step S106 of the platooning management process; and

FIG. 12 is a flowchart of a routine executed in an external device that receives remote control information.

### DETAILED DESCRIPTION

Hereinafter, embodiments of the present disclosure will be described with reference to the accompanying drawings. However, it is to be understood that even when the number, quantity, amount, range or other numerical attribute of each element is mentioned in the following description of the embodiments, the present disclosure is not limited to the mentioned numerical attribute unless explicitly described otherwise, or unless the present disclosure is explicitly specified by the numerical attribute theoretically. Furthermore, structures or steps or the like that are described in conjunction with the following embodiments are not necessarily essential to the present disclosure unless explicitly described otherwise, or unless the present disclosure is explicitly specified by the structures, steps or the like theoretically.

### 1. First Embodiment

### 1-1. Driving Support Control

The platooning system 100 of the present embodiment includes a plurality of vehicles 1 that perform platooning. Each vehicle 1 has a function for performing driving support control. Here, before the description of the platooning system 100, an outline of the driving support control of the vehicle 1 will be described first.

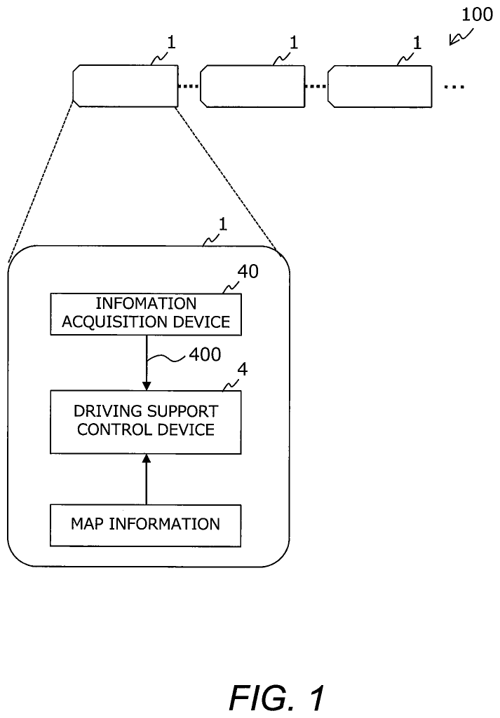

FIG. 1 is a conceptual diagram for explaining a function related to driving support control of a vehicle applied to a platooning system according to the present embodiment. An information acquisition device 40 and a driving support control device (driving support controller) 4 are installed on the vehicle 1.

The information acquisition device 40 acquires various types of information using sensors mounted on the vehicle 1. The information acquired by the sensor mounted on the vehicle 1 includes information indicating a driving environment of the vehicle 1. In the following description, this information is referred to as “driving environment information 400”. The driving environment information 400 includes vehicle position information indicating a position of the vehicle 1, vehicle state information indicating a state of the vehicle 1, surrounding situation information indicating a surrounding situation of the vehicle 1, and the like.

The driving support control device 4 performs driving support control for supporting the driving of the vehicle 1 based on the driving environment information 400. More specifically, the driving support control includes at least one of steering control, acceleration control, and deceleration control. Examples of such driving support control include autonomous driving control, path-following control, Lane Departure Alert (LDA), Pre-Collision System (PCS), Adaptive Cruise Control (ACC), and the like.

In the driving support control, map information is used. The map information includes various information associated with a position. The position is an absolute position and is defined in an absolute coordinate system (latitude, longitude, altitude). The map information is not limited to general road maps or navigation maps, and may include map information of various viewpoints. For example, the map information may include the position of a stationary object on a road, such as a guardrail, a wall, or the like, and a characteristic object, such as a road surface, a white line, a pole, a signboard, or the like.

In the present embodiment, the driving support control is classified into a plurality of levels. In the following description, the level of the driving support control is referred to as “driving support level”. The plurality of driving support levels can be compared with each other. The higher the driving support level, the more the driving support control device 4 is responsible for driving operations (driving tasks). It can be said that the driving support level represents the degree (delegation degree) to which the driver delegates the operation of the vehicle 1 to the driving support control device 4.

Driving support levels are lowest in LV-1 and highest in LV-5. For example, the content of the driving support levels LV-1 to LV-5 is as follows.

LV-1: The driving support control device performs sub-tasks of the driving tasks relating to either the steering control or the acceleration/deceleration control. For example, limited driving support control using ACC: Adaptive Cruise Control, path-following control, or the like is applicable.

LV-2: The driving support control device performs sub-tasks of the driving tasks related to both steering control and acceleration/deceleration control. For example, driving support control for simultaneously performing a plurality of controls such as adaptive cruise control (ACC) and path-following control is applicable.

LV-3: In a limited driving support feasible area, the driving support control device performs all driving tasks related to steering control and acceleration/deceleration control. The driver may take his hand off the steering. However, the driver is required to monitor the surroundings of the vehicle 1. The driver performs manual operation as necessary.

LV-4: In a limited driving support feasible area, the driving support control device performs all driving tasks related to steering control and acceleration/deceleration control. The driver does not have to monitor the surrounding conditions of the vehicle 1. The driver is allowed to perform other operations (second tasks). In an emergency, the driving support control device requests the driver to start manual driving. However, the driver is not expected to respond to the requirement.

LV-5: In all areas, the driving support control device performs all driving tasks related to steering control and acceleration/deceleration control. The driver does not have to monitor the surrounding conditions of the vehicle 1. The driver is allowed to perform other operations (second tasks). In an emergency, the driving support control device automatically retracts the vehicle to a safe location.

In this class of operation support levels, the driver performs some of the driving tasks in LV-1 and LV-2, while the driving support control device performs all of the driving tasks in LV-3 to LV-5. In the following descriptions, LV-1 and LV-2 are also referred to as “low-grade driving support level” and LV-3 to LV-5 are also referred to as “high-grade driving support level”. The classification of the driving support level is not limited to that described above. For example, each driving support level may be hierarchized more finely. In addition, the classification of the driving support level may coincide with the classification of a typical auto driving level based on J3016 issued by SAE (Society of Automotive Engineers).

Further, the driving support control device 4 generates a travel plan of the vehicle 1 based on the map information and the driving environment information 400. The travel plan includes a target route to a destination and a local target trajectory (a target trajectory in a lane and a target trajectory for lane change). The travel plan includes a vehicle travel plan for following a target trajectory, following a traffic rule, and avoiding an obstacle, and the like. The driving support control device 4 executes driving support control so that the vehicle 1 travels in accordance with the travel plan.

### 1-2. Summary of Platooning System

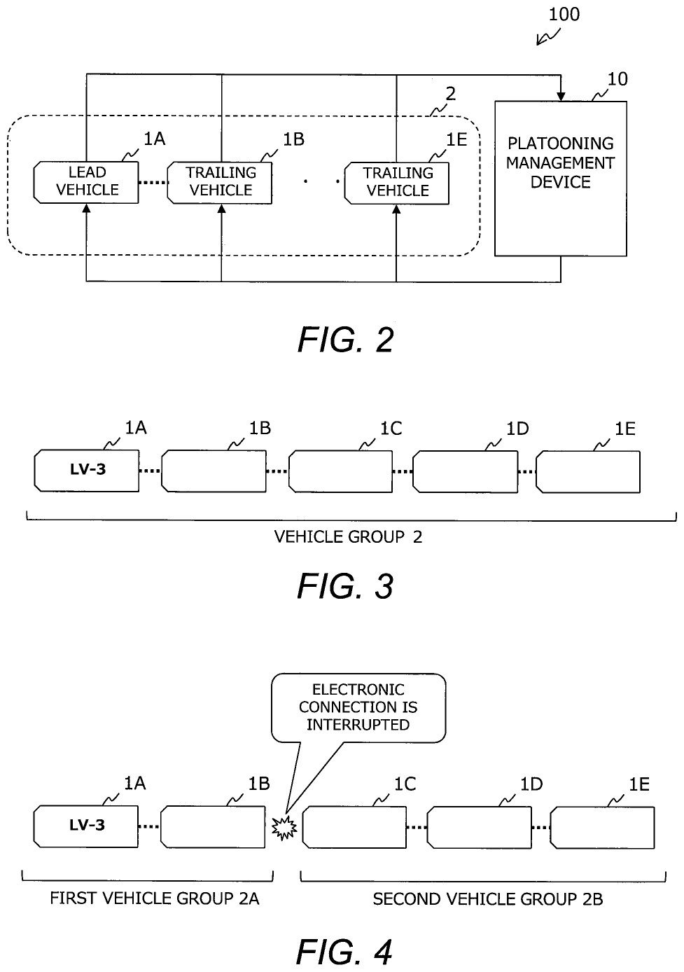

FIG. 2 is a diagram schematically showing a configuration of a platooning system according to the present embodiment. The platooning system 100 is a system that performs platooning using electronic connection. The electronic connection indicates that a plurality of vehicles 1 positioned in a row are electrically connected to each other by wireless communication. In the following description, a plurality of vehicles 1 that are electronically connected are referred to as “vehicle group 2”. In the vehicle group 2, the vehicle 1 located at the head is denoted as “lead vehicle 1A”, and the vehicle 1 following behind the lead vehicle is sequentially denoted as “trailing vehicle 1B”, “trailing vehicle 1C” . . . .

The platooning system 100 includes the vehicle group 2 and a platooning management device (platooning manager) 10. The vehicle group 2 of the present embodiment is composed of five vehicles 1. The number of vehicles 1 constituting the vehicle group 2 is not limited. The kind of the plurality of vehicles 1 constituting the vehicle group 2 is not limited as long as it is a vehicle on which the above-mentioned driving support control device 4 is installed. Also, the driving support levels that can be implemented in the driving support control devices 4 of the respective vehicles 1 need not be the same. For example, in the vehicle group 2, the vehicle 1 capable of LV-3 driving support control and a vehicle 1 capable of LV-2 driving support control may coexist. Further, there is no particular limitation on whether or not the driver boards each of the plurality of vehicles 1 constituting the vehicle group 2. For example, the vehicle group 2 may include the vehicle 1 in LV-4 where the driver is not on board and the other vehicle 1 in LV-2 where the driver is on board.

The platooning management device 10 sets a platoon of the vehicle group 2 in which the plurality of vehicles 1 are electronically connected, and controls the platooning of the vehicle group 2. More specifically, the platooning management device 10 acquires the driving environment information 400 and the travel plan from each vehicle 1. The platooning management device 10 performs a vehicle group management process of generating and updating vehicle group information based on the acquired travel plan and driving environment information 400 of each vehicle 1. The vehicle group information includes, in addition to the target route to the destination, information on the order of the platoons of the vehicles 1 constituting the vehicle group 2. When there is a change in the acquired driving environment information 400, the platooning management device 10 renewals the vehicle group information, and transmits the updated vehicle group information to each vehicle 1 of the vehicle group 2. Each vehicle 1 of the vehicle group 2 performs electronic connection between the vehicles based on the received vehicle group information.

FIG. 3 is a diagram showing an example of a platoon of vehicle group organized. In the example shown in this drawing, the vehicle group 2 is organized by five vehicles 1 arranged in a row. The vehicles 1 are electronically connected to each other. The lead vehicle 1A of the platoon tows the platoon to the destination by using the driving support control corresponding to its own driving support level. Here, it is assumed that the driving support level of the lead vehicle 1A is LV-3 which is the high-grade driving support level. In this instance, the lead vehicle 1A tows the trailing vehicles 1B to 1E by driving support control based on the LV-3.

Here, there is a case where the electronic connection between the vehicles of the vehicle group 2 is interrupted. FIG. 4 is a diagram showing an example of a case where the electronic connection is interrupted in a part of the platoon of the vehicle group. In the example shown in this drawing, the electronic connection between the vehicle B and the vehicle C is interrupted and the vehicle group 2 is divided into two. In the following explanation, the divided vehicle group on the front side is denoted as “first vehicle group 2A”, and the vehicle on the rear side is denoted as “second vehicle group 2B”. The vehicles 1A to 1B of the first vehicle group 2A can continue the platooning, but the vehicles 1C to 1E of the second vehicle group 2B cannot perform the platooning following the lead vehicle 1A.

In the platooning system 100 of the present embodiment, when the vehicle group 2 is divided into the first vehicle group 2A and the second vehicle group 2B by the interruption of the electronic connection, the second vehicle group 2B determines the behavior of the platooning according to the driving support level of the vehicle 1C that has newly become the lead vehicle. More specifically, the platooning management device 10 executes a level determination process for determining the driving support level of the vehicle 1C that has newly become the lead vehicle. Then, the platooning management device 10 executes a platooning process for controlling the operation of the platooning of the second vehicle group 2B based on the determined driving support level.

### 1-3. Platooning Process Based on Driving Support Level

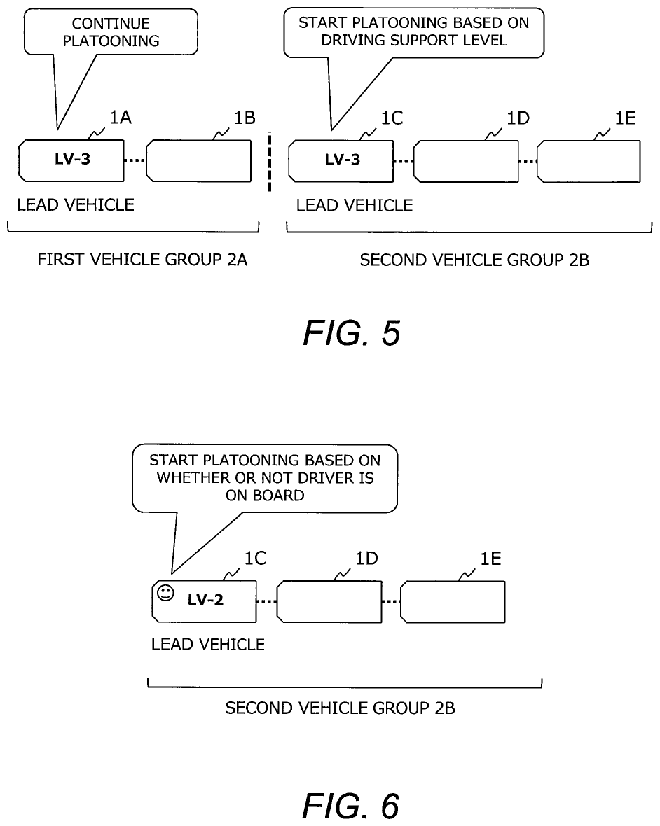

FIG. 5 is a diagram for explaining a platooning process executed when the electronic connection is interrupted. As shown in this drawing, the first vehicle group 2A continues platooning that has been performed before the interruption of the electronic connection. On the other hand, when the driving support level of the lead vehicle 1C is equal to or higher than the predetermined level, the second vehicle group 2B performs the platooning by using the driving support control based on the executable driving support level. The predetermined level can be set, for example, in a LV-3 where the driving support control device performs all the driving tasks relating to the steering control and the acceleration/deceleration control.

When the driving support level of the lead vehicle 1C is the LV-3 to LV-5 high-grade driving support level, the platooning management device 10 executes a platoon driving process of the second vehicle group 2B by using the driving support control based on the high-grade driving support level. The process of platooning is also referred to as “high-grade platooning process”. According to the high-grade platooning process, the lead vehicle 1C tows the second vehicle group 2B by using the driving support control of the LV-3 to LV-5. At this time, if the second vehicle group 2B belongs to a predetermined driving support feasible area, the platooning management device 10 executes, for example, an evacuation traveling process for moving the second vehicle group 2B to the safest place in the driving support feasible area, for example, a parking area or a servicing area. Here, the prescribed driving support feasible area is not limited to a geographical area, and indicates an area including an environment condition, a traffic condition, a speed condition, and a temporal condition. When the driving support level of the lead vehicle 1C is LV-5, the entire area is regarded as a driving support feasible area.

When the second vehicle group 2B belongs to a predetermined operation support possible area, if the set destination belongs to the driving support feasible area, the lead vehicle 1C may move the second vehicle group 2B to the destination.

FIG. 6 is a diagram for explaining an example of the platooning executed when the driving support level of the lead vehicle of the second vehicle group is the low-grade driving support level. As shown in this drawing, when the driving support level of the lead vehicle 1C is the LV-1 to LV-2 low-grade driving support level, the driving support control device 4 of the lead vehicle 1C cannot execute all the driving tasks. In this case, the platooning management device 10 determines the behavior of the platooning of the second vehicle group 2B according to whether or not the driver is on board the lead vehicle 1C. This process of platooning is also referred to as “low-grade platooning process”. More specifically, the platooning management device 10 acquires driver information indicating whether or not the driver is on board the lead vehicle 1C. This process is also referred as “driver information acquisition process”. Then, when it is determined from the acquired driver information that the driver is on board the lead vehicle 1C, the platooning management device 10 performs the platooning of the second vehicle group 2B by using the driving support control based on the low-grade driving support level of the LV-1 to LV-2. This process of platooning is also referred to as “manual driving process” because the driver performs a part of the driving task.

On the other hand, when the driver is not on board the lead vehicle 1C, the platooning management device 10 seeks to perform a remote operation from an external device. The remote operation from the external device includes not only a manual remote operation by an external operator but also a remote operation by an external system. The platooning management device 10 executes an information transmitting process for transmitting information required for remote control of the second vehicle group 2B to an external device such as a management center. This information is also referred as “remote control information”. The remote control information includes the driving support level of the lead vehicle 1C of the second vehicle group 2B, the presence or absence of the driver, and information on the position or the destination of the second vehicle group. The management center determines whether or not remote control is possible based on the received remote control information, and transmits the result to the platooning management device 10. When the remote control of the second vehicle group 2B is not possible, the platooning management device 10 stops the second vehicle group 2B in a park-able area in the vicinity. On the other hand, when the remote control of the second vehicle group 2B is enabled, the remote control from the management center is executed.

In the low-grade platooning process, when the driving support level of the lead vehicle 1C is the low-grade driving support level, the information transmitting process may be performed without the driver information acquisition process. According to such a process, regardless of whether or not the driver is on board the lead vehicle 1C, the behavior of the platooning of the second vehicle group can be determined in accordance with the determination by the external device.

As described above, according to the platooning system 100 of the present embodiment, even when the electronic connection is interrupted and the vehicle group 2 is divided into two, the platooning of the separated second vehicle group 2B can be optimized.

Hereinafter, the platooning system 100 according to the present embodiment will be described in more detail. In the following explanation, a case in which five vehicles 1A to 1E constitute the vehicle group 2 and perform platooning is exemplified.

### 2. Embodiment of Platooning System 100

### 2-1. Configuration Example of Driving Control Device

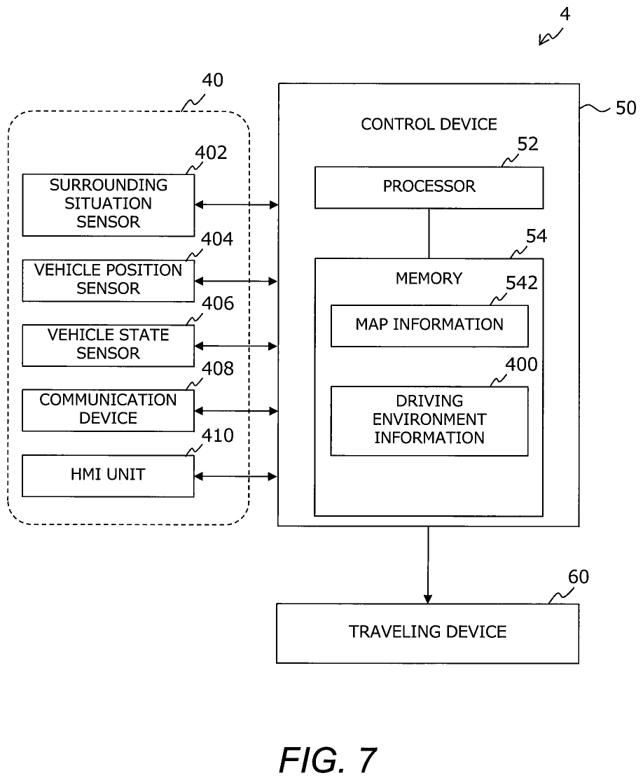

FIG. 7 is a block diagram showing a configuration example of a driving support control device of the vehicle applied to the platooning system according to the present embodiment.

The driving support control device 4 is installed on the vehicle 1. The driving support control device 4 includes an information acquisition device 40, a control device (controller) 50, and a traveling device 60.

The information acquisition device 40 includes a surrounding situation sensor 402, a vehicle position sensor 404, a vehicle state sensor 406, a communication device 408, and an HMI (Human Machine Interface) unit 410. The surrounding situation sensor 402 recognizes (detects) a situation around the vehicle 1. Examples of the surrounding situation sensor 402 includes a camera (image pickup apparatus), a LIDAR (Laser Imaging Detection and Ranging), a radar, and the like. The camera takes an image of surrounding conditions of the vehicle 1. The rider detects a target object around the vehicle 1 by using a laser beam. The radar uses radio waves to detect the landmarks around the vehicle 1.

The vehicle position sensor 404 detects the position and orientation of the vehicle 1. For example, the vehicle position sensor 404 may include a GPS (Global Positioning System) sensor. The GPS sensor receives signals transmitted from a plurality of OPS satellites, and calculates the position and orientation of the vehicle 1 based on the received signals.

The vehicle state sensor 406 detects the state of the vehicle 1. The state of the vehicle 1 includes a speed, an acceleration, a steering angle, a yaw rate, and the like of the vehicle 1. Further, the state of the vehicle includes whether or not the driver is on board the vehicle 1, and the driving operation of the driver. The driving operation includes an accelerator operation, a brake operation, and a steering operation of the vehicle 1.

The communication device 408 communicates with the vehicle and the outside. For example, the communication device 408 communicates with an external device of the vehicle 1 via a communication network. Here, the external devices include the platooning management device 10 or the management center. The communication device 408 performs vehicle-to-vehicle communication (V2V communication) with other vehicles in the vicinity. Communication is performed between the vehicle and the outside. The communication device 408 may perform vehicle-to-roadside-infrastructure communication (V2I communication) with the surrounding infrastructure.

The HMI unit 410 is an interface for providing information to the driver and accepting information from the driver. Specifically, the HMI unit 410 includes an input device and an output device. Examples of the input device include a touch panel, a switch, and a microphone. Examples of the output device include a display device, a speaker, and the like.

The traveling device 60 includes a steering device, a driving device, and a braking device. The steering device steers wheels of the vehicle 1. The driving device is a driving source for generating a driving force of the vehicle 1. Examples of the driving device include an engine or an electric motor. The brake device generates a braking force on the vehicle 1.

The control device 50 is a microcomputer including a processor 52 and a memory 54. The control device 50 is also referred to as “ECU (Electronic Control Unit)”. The processor 52 executes the program stored in the memory 54, thereby executing various processes by the control device 50.

For example, the control device 50 acquires necessary map information 542 from a map database. When the map database is installed in the vehicle 1, the control device 50 acquires necessary map information 542 from the map database. On the other hand, when the map database exists outside the vehicle 1, the control device 50 acquires necessary map information 542 through the communication device 408. The map information 542 is stored in the memory 54, and is read out and used as appropriate.

Further, the control device 50 acquires the driving environment information 400. The driving environment information 400 is stored in the memory 54, and is read out and used as appropriate. Specifically, the driving environment information 400 includes surrounding situation information, vehicle position information, vehicle state information, driving support level information, electronic connection information, and distribution information. The surrounding situation information indicates the surrounding situation of the vehicle 1. The surrounding situation information is information obtained from the detection result by the surrounding situation sensor 402. The control device 50 acquires the surrounding situation information based on the detection result of the surrounding situation sensor 402.

The vehicle position information is information indicating the position and direction of the vehicle. The control device 50 acquires vehicle position information from the vehicle position sensor 404. Further, the control device 50 may perform a well-known self-position estimation process (localization) by using target object information included in the surrounding situation information to improve the accuracy of the vehicle position information.

The vehicle state information is information indicating the state of the vehicle 1. The state of the vehicle 1 includes a speed, an acceleration, a steering angle, a yaw rate, and the like of the vehicle 1. Further, the state of the vehicle 1 includes whether or not the driver is on board the vehicle 1, and the driving operation of the driver. The driving operation includes an accelerator operation, a brake operation, and a steering operation of the vehicle 1. The control device 50 acquires vehicle state information from the vehicle state sensor 406.

The driving support level information is information indicating the driving support level of the vehicle 1. The driving support level information is unique information determined by the driving support control device 4 installed on the vehicle 1. Further, the electronic connection information is information indicating a state of electronic connection or disruption with the surrounding vehicle.

The distribution information is information obtained through the communication device 408. The control device 50 acquires the distribution information by communicating with the outside by using the communication device 408. For example, the distribution information includes road traffic information distributed from the infrastructure. The distribution information also includes driving environment information obtained from surrounding vehicles which are electronically connected by vehicle-to-vehicle communication.

The control device 50 generates a travel plan of the vehicle 1 based on the map information 542 and the driving environment information 400. The driving plan includes a target route to a destination and a local target trajectory (a target trajectory in a lane and a target trajectory for lane change). The travel plan includes a vehicle travel plan for following a target trajectory, following a traffic rule, and avoiding an obstacle, and the like. The control device 50 controls the traveling device 60 so that the vehicle 1 executes the driving support control according to the travel plan.

### 2-2. Configuration Example of Platooning System 100

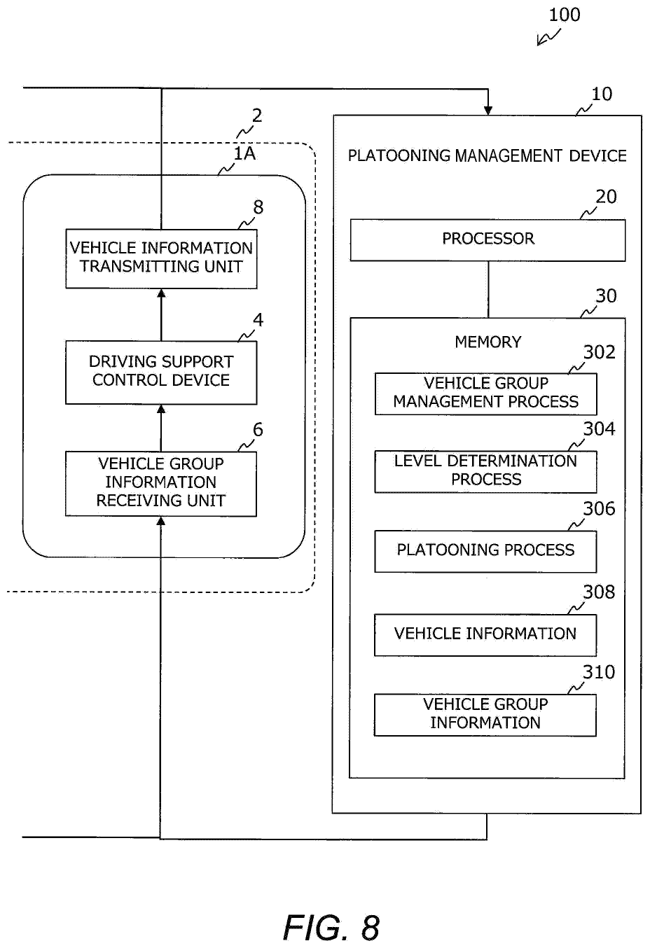

FIG. 8 is a block diagram showing an example of the configuration of the platooning system according to the first embodiment. As described above, the platooning system 100 includes the platooning management device 10 and the vehicle group 2. The vehicle group 2 is composed of the plurality of vehicles 1. In FIG. 8, only the configuration of the lead vehicle 1A of the plurality of vehicles 1 is shown, but other vehicles 1 are assumed to have the same configuration.

The lead vehicle 1A includes the driving support control device 4, a vehicle group information receiving unit 6, and a vehicle information transmitting unit 8. The vehicle group information receiving unit 6 receives vehicle group information transmitted from the platooning management device 10. The driving support control device 4 performs electronic connection with the specified vehicle 1 based on the received vehicle group information, and performs driving support control of the vehicle 1A. The vehicle information transmitting unit 8 transmits the vehicle information of the vehicle 1A to the platooning management device 10. The vehicle information includes the driving environment information 400 of the vehicle 1A and the travel plans.

The platooning management device 10 is a microcomputer including a processor 20 and a memory 30. The platooning management device 10 is also referred to as “ECU (Electronic Control Unit)”. The processor 20 executes the program stored in the memory 30, thereby executing various processes by the platooning management device 10. The platooning management device 10 may be configured as an external apparatus such as an external server, or a part or all of the functions of the platooning management device 10 may be mounted on any vehicle 1.

The program stored in the memory 30 of the platooning management device 10 includes a vehicle group management process 302, a level determination process 304, and a platooning process 306. The vehicle group management process 302 generates and updates information on the vehicle group 2 that performs the platooning. Specifically, in the vehicle group management process 302, the platooning management device 10 acquires vehicle information 308 from each vehicle 1. The vehicle information 308 includes the driving environment information 400 of each vehicle 1 described above. The acquired vehicle information 308 is stored in the memory 30, and is read out and used as appropriate. Then, based on the acquired vehicle information 308 of each vehicle 1, the platooning management device 10 generates vehicle group information 310 for performing the platooning. The vehicle group information 310 includes information on the plurality of vehicles 1 included in the vehicle group 2 and the order of the fleet. More specifically, the platooning management device 10 sets a plurality of vehicles 1 that are directed to a common destination among the vehicles existing in the vicinity to one vehicle group 2. In addition, the platooning management device 10 sets the platoon order of the vehicle group 2 based on the position and the like of each vehicle 1 included in the vehicle group 2. The set vehicle group information 310 is stored in the memory 30, read out as appropriate, and used. The set vehicle group information 310 is also transmitted to each vehicle 1 constituting the vehicle group 2.

The level determination process 304 is a process for determining the driving support level of the lead vehicle of the second vehicle group 2B when the vehicle group 2 is divided into the first vehicle group 2A and the second vehicle group 2B by the vehicle group management process 302. More specifically, in the level determination process 304, the platooning management device 10 identifies the lead vehicle (in this case, the vehicle 1C) of the second vehicle group 2B based on the vehicle group information 310. Then, based on the vehicle information 308, the platooning management device 10 determines the driving support level of the lead vehicle 1C.

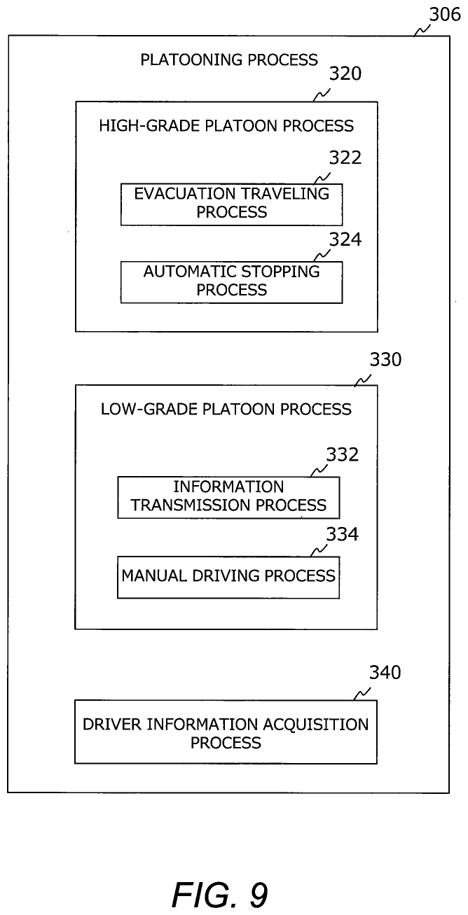

The platooning process 306 is a process for controlling the operation of the platooning of the vehicle group 2 based on the vehicle group information 310. FIG. 9 is a block diagram showing an example of the configuration of various processes included in the platooning process. As shown in this drawing, the platooning process 306 includes a high-grade platooning process 320, a low-grade platooning process 330, and a driver information acquisition process 340. The high-grade platooning process 320 further includes an evacuation traveling process 322 and an automatic stopping process 324. The low-grade platooning process 330 further includes an information transmission process 332 and a manual driving process 334. Hereinafter, a specific process of the platooning process 306 executed in the platooning system 100 according to the present embodiment will be described with reference to a flowchart.

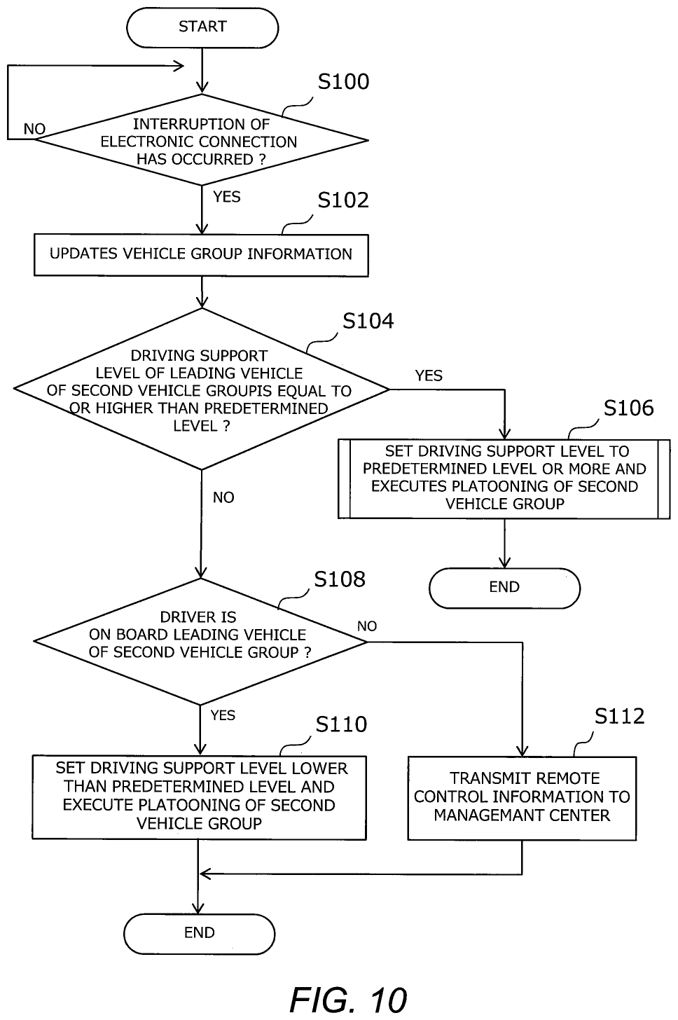

FIG. 10 is a flowchart showing a routine of a platooning management process executed in the platooning system according to the first embodiment. The routine shown in FIG. 10 is executed by the platooning management device 10 while the platooning of the vehicle group 2 composed of the five vehicles 1A to 1E is being executed.

When the routine shown in FIG. 10 is started, the platooning management device 10 determines whether or not the interruption of the electronic connection has occurred between any of the vehicles on the vehicle 1A to 1E (step S100). Here, the platooning management device 10 determines whether or not the information indicating that the electronic connection of any vehicle of the vehicle 1A to 1E has been interrupted has been received. As a result, if it is determined that the determination is not satisfied, the process of step S100 is executed again.

On the other hand, if the determination of the step S100 is satisfied, the platooning management device 10 updates the vehicle group information (step S102). Here, the platooning management device 10 updates the vehicle group information based on the received driving environment information of each vehicle 1. More specifically, the platooning management device 10 divides the vehicle group 2 between the vehicles in which the electronic connection is interrupted. The platooning management device 10 updates the vehicle group information by setting the divided vehicle group in the front as the first vehicle group 2A and setting the vehicle group in the rear as the second vehicle group 2B. The updated vehicle group information is stored in the memory 30. The updated vehicle group information is also transmitted to each vehicle 1 of the vehicle group 2.

Next, the platooning management device 10 determines whether or not the driving support level of the lead vehicle 1C of the second vehicle group 2B is equal to or higher than a predetermined level (step S104). Here, the platooning management device 10 reads the driving support level information of the lead vehicle 1C of the second vehicle group 2B. Then, the platooning management device 10 determines whether or not the read driving support level is equal to or higher than the predetermined level. The predetermined level here is a threshold value for determining whether the driving support level is the high-grade driving support level or the low-grade driving support level. Here, the predetermined level is set to, for example, LV-3.

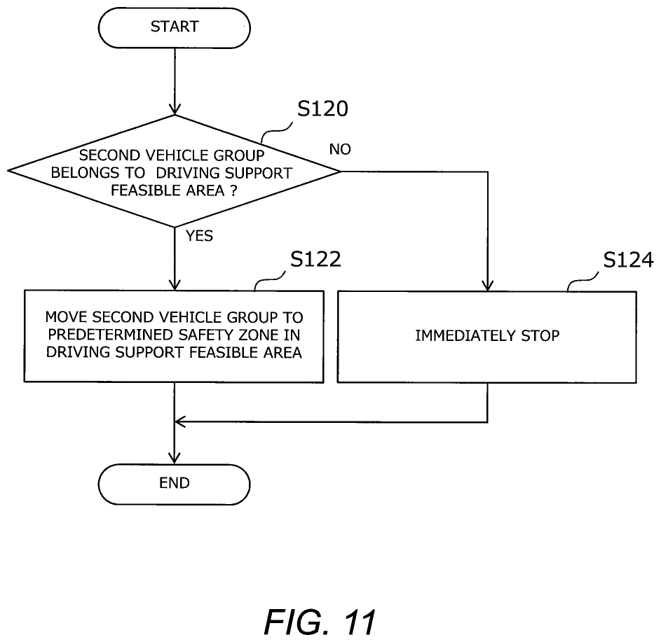

As a result of the process of the above-mentioned step S104, if it is confirmed that the determination is satisfied, even if the driver is not on board the lead vehicle 1C of the second vehicle group 2B, it can be determined that the platooning can be executed by the driving support control based on the high-grade driving support level. In the following step, the platooning management device 10 sets the driving support level of the lead vehicle 1C to the predetermined level (e.g. LV-3) or more, and executes the platooning of the second vehicle group 2B (step S106). Specifically, the platooning management device 10 executes a subroutine shown in FIG. 11, which will be described later.

On the other hand, as a result of the process of the above-mentioned step S104, if the determination is not satisfied, it can be determined that the driving support level is the low-grade driving support level. In this case, the platooning management device 10 determines whether the driver is on board the lead vehicle 1C (step S108). Here, the platooning management device 10 reads the vehicle status information of the lead vehicle 1C stored in the memory 30. Then, the platooning management device 10 determines whether or not the driver is on board based on the vehicle state information. As a result, when it is determined that the determination is satisfied, the platooning management device 10 sets the driving support level of the lead vehicle 1C to a feasible level lower than the predetermined level (e.g. LV-3), and executes the platooning of the second vehicle group 2B (step S110). When the process of step S110 is completed, the present routine is terminated.

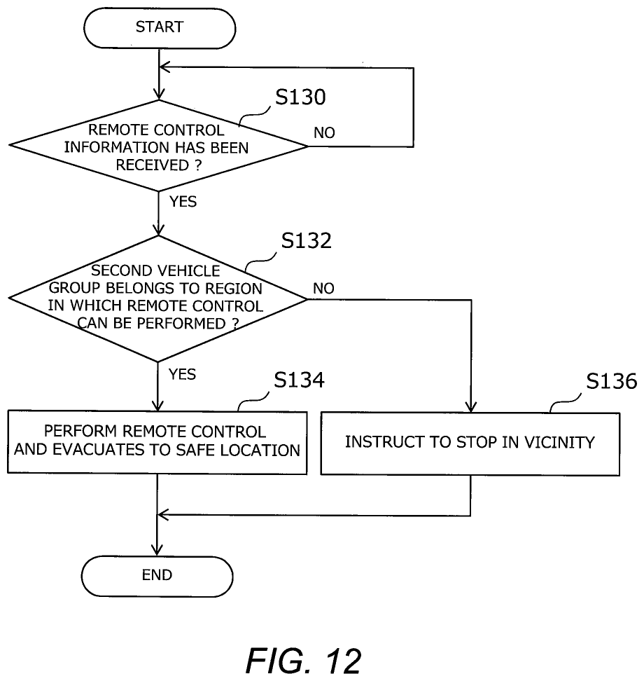

On the other hand, as a result of the process of the above-mentioned step 108, if the determination is not satisfied, it can be determined that the lead vehicle 1C has a lower feasible driving support level than the LV-3 level, and therefore, it is difficult to lead the platooning of the second vehicle group 2B in the driverless state. In this case, the platooning management device 10 transmits the remote control information to the external device such as the management center (step S112). The remote control information here includes the driving support level of the lead vehicle 1C, the presence or absence of the driver, and information related to the position or the destination of the second vehicle group. The process executed in the external device that has received the remote control information will be described with reference to a flowchart shown in FIG. 12, which will be described later. When the process of step S112 is completed, the present routine is terminated.

FIG. 11 is a flow chart showing a subroutine executed in the step S106 of the platooning management process. In the subroutine shown in FIG. 11, the platooning management device 10 determines whether or not the second vehicle group 2B belongs to the driving support feasible area (step S120). Here, the driving support feasible area indicates an automated driving feasible area set corresponding to the driving support level of the lead vehicle 1C. The driving support feasible area is not limited to a geographical area, and indicates an area including an environment, a traffic condition, a speed condition, and a temporal condition. Based on the map information and the driving environment information, the platooning management device 10 specifies the driving support feasible area, and compares the driving support feasible area with the position of the second vehicle group 2B.

As a result of the above-mentioned step S120, if the determination is satisfied, the platooning management device 10 moves the second vehicle group 2B to a predetermined safety zone in the driving support feasible area (step S122). The predetermined safety zones can be set, for example, at the safest place in the driving support feasible area, such as a parking area or a service area.

On the other hand, when the determination of the S120 of steps is not satisfied, it can be determined that the lead vehicle 1C of the second vehicle group 2B is in an area in which the driving support control cannot be performed at the predetermined driving support level or higher. In this instance, the platooning management device 10 immediately stops the platooning of the second vehicle group 2B (step S124).

FIG. 12 is a flowchart of a routine executed in an external device that receives remote control information. In this routine, the external device determines whether or not the remote control information has been received (step S130). As a result, when it is determined that the determination is not satisfied, the external device executes the process of step S130 again.

On the other hand, when the determination is satisfied in the process of the step S130, the external device determines whether or not the second vehicle group 2B belongs to the region in which the remote control can be performed, based on the received remote control information (step S132). As a result, if the determination is satisfied, the external device performs remote control of the lead vehicle 1C of the second vehicle group 2B, and evacuates the second vehicle group 2B to a safe location (step S134). On the other hand, if the determination of the step S132 is not satisfied, the external device instructs the platooning management device 10 to stop the second vehicle group 2B in the vicinity (step S136).

According to such a platooning management process, even when the electronic connection of the vehicle group 2 during the platooning is interrupted, it is possible to optimize the platooning of the divided second vehicle group 2B.

In the platooning system 100 according to the first embodiment described above, when the driving support level of the lead vehicle 1C is the low-grade driving support level, the remote control information may be transmitted to the external device such as the management center without determining whether or not a driver is on board the lead vehicle 1C. Such control may be performed, for example, when the determination of the step S104 of the routine shown in FIG. 10 is not satisfied, so that the routine shifts to the process of the step S112. According to such a process, regardless of whether or not the driver is on board the lead vehicle 1C, the behavior of the platooning of the second vehicle group can be determined in accordance with the determination by the external device.

It should be noted that, in the platooning system 100 of the first embodiment, the processor 20 of the platooning management device 10 corresponds to the “processor” of the first disclosure, and the memory 30 of the platooning management device 10 corresponds to the “memory” of the first disclosure. In addition, in the platooning system 100 according to the first embodiment, the process of step S104 is executed by executing the level determination process 304 corresponding to the “level determination process” of the first disclosure among the programs stored in the memory 30, and the processes of steps S106 to S112 are executed by executing the platooning process 306 corresponding to the “platooning process” of the first disclosure.

Further, in the platooning system 100 according to the first embodiment, the process of the step S106 is executed by executing the high-grade platooning process 320 corresponding to the “high-grade platooning process” of the second disclosure, among the programs stored in the memory 30.

In addition, in the platooning system 100 according to the first embodiment, the processes of steps S120 and S122 are executed by executing the evacuation traveling process 322 corresponding to the “evacuation traveling process” of the third disclosure, among the programs stored in the memory 30.

In addition, in the platooning system 100 according to the first embodiment, the automatic stopping process 324 corresponding to the “automatic stop process” of the fourth disclosure is executed among the programs stored in the memory 30, thereby executing the processing of steps S120 and S124.

Further, in the platooning system 100 according to the first embodiment, the process of step S108 is executed by executing the driver information acquisition process 340 corresponding to the “driver information acquisition process” of the sixth disclose among the programs stored in the memory 30, and the process of step S108, the S110, or the S112 is executed by executing the low-grade platooning process 330 corresponding to the “low-grade platooning process” of the sixth disclosure.

Further, in the platooning system 100 according to the first embodiment, the process of the step S112 is executed by executing the information transmission process 332 corresponding to the “information transmission process” of the seventh disclosure, among of the programs stored in the memory 30.

Further, in the platooning system 100 according to the first embodiment, the manual driving process 334 corresponding to the “manual driving process” of the eighth disclosure is executed among the programs stored in the memory 30, whereby the process of the step S110 is executed.

What is claimed is:

1. A platooning system for performing platooning by forming a platoon by electrically connecting a plurality of vehicles arranged in a row to each other, and automatically causing a trailing vehicle positioned behind a lead vehicle of the platoon to follow the lead vehicle, the platooning system comprising:
a processor to execute a program defining an operation of the platooning; and
a memory to store the program,
wherein the program includes a level determination process and a platooning process,
wherein when a plurality of the vehicles formed the platoon is divided into a first vehicle group and a second vehicle group behind the first vehicle group by interrupting a part of an electronic connection, the level determination process is configured to determine a driving support level to be realized by a lead vehicle of the second vehicle group,
wherein the platooning process is configured to control the operation of the platooning by the second vehicle group based on the determined driving support level.

2. The platooning system according to claim 1,
wherein the platooning process includes a high-grade platooning process, and when the driving support level determined by the level determination process is a high-grade driving support level equal to or higher than a predetermined level, the high-grade platooning process is configured to perform platooning of the second vehicle group by driving support based on the high-grade driving support level.

3. The platooning system according to claim 2,
wherein the high-grade platooning process includes an evacuation traveling process, and when a position of the second vehicle group belongs to a driving support feasible area corresponding to the high-grade driving support level, the evacuation traveling process is configured to move the second vehicle group to a predetermined safety zone included in the driving support feasible area by the driving support.

4. The platooning system according to claim 2,
wherein the high-grade platooning process includes an automatic stopping process, and when a position of the second vehicle group does not belong to a driving support feasible area corresponding to the high-grade driving support level, the automatic stopping process is configured to stop the second vehicle group by the driving support.

5. The platooning system according to claim 2,
wherein the platooning process includes an information transmission process, and when the driving support level determined by the level determination process is a low-grade driving support level equal to or lower than the predetermined level, the information transmission process is configured to transmit information of the lead vehicle of the second vehicle group to an external device.

6. The platooning system according to claim 2,
wherein the platooning process includes a driver information acquisition process for acquiring driver information indicating whether or not a driver is on board the lead vehicle of the second vehicle group, and a low-grade platooning process for controlling the operation of the platooning of the second vehicle group based on the driver information when the driving support level determined by the level determination process is a low-grade driving support level lower than the predetermined level.

7. The platooning system according to claim 6,
wherein the low-grade platooning process includes an information transmission process, and when a driver is not on board the lead vehicle of the second vehicle group, the information transmission process is configured to transmit information of the lead vehicle of the second vehicle group including the driving support level and the driver information to an external device.

8. The platooning system according to claim 6,
wherein the low-grade platooning process includes a manual driving process, and when a driver is on board the lead vehicle of the second group, the manual driving process is configured to perform the platooning of the second vehicle group by driving support based on the low-grade driving support level.
